(19) United States
(12) Patent Application Publication
(10) Pub. No.: US 2021/0277539 A1
(43) Pub. Date: Sep. 9, 2021

(54) GEOTEXTILE WITH CONDUCTIVE PROPERTIES

(71) Applicant: IMAGINE INTELLIGENT MATERIALS LIMITED, Menai (AU)

(72) Inventors: Phillip AITCHISON, Sydney (AU); Vito GIORGIO, Sydney (AU); Grant MATHIESON, Athelstone (AU)

(73) Assignee: IMAGINE INTELLIGENT MATERIALS LIMITED, Menai (AU)

(21) Appl. No.: 17/223,703

(22) Filed: Apr. 6, 2021

Related U.S. Application Data
(63) Continuation of application No. 16/075,126, filed on Aug. 2, 2018, now abandoned.

(30) Foreign Application Priority Data
Feb. 3, 2016 (AU) 2016900348
Feb. 3, 2017 (AU) PCT/AU2017/050091

(51) Int. Cl. D01F 1/09; D06M 11/74; B32B 5/02; H01B 1/04; B32B 15/08; B32B 7/12; B32B 3/02; G01M 3/40; D06N 3/00; G01M 3/16; B32B 27/06; B32B 1/08

(52) U.S. Cl. CPC D01F 1/09; D01F 6/06; B32B 5/02; H01B 1/04; B32B 15/08; B32B 7/12; B32B 3/02; G01M 3/40; D06N 3/0036; D06N 3/0063; G01M 3/16; B32B 27/06; D06N 3/0011; B32B 1/08; D06M 11/74

(57) ABSTRACT

An electrically conductive geotextile incorporating graphene and a method of using conductive properties in same to detect anomalies in said textile.

### TECHNICAL FIELD

The invention relates to the field of geotextile manufacture. In particular, the invention relates to a geotextile that has conductive properties.

### BACKGROUND OF THE INVENTION

Textiles are widely used as protective layers when building water retention facilities (e.g. dams and ponds) or water guidance facilities (e.g. drainage and canals). These textiles can be deployed on a large scale and may potentially cover many thousands of square meters. These protective layers are often referred to as “geotextiles” and can serve many purposes, but they are predominately not in themselves a barrier to water ingress. Where water barrier properties are required an additional waterproof layer is typically used.

Water barrier layers, such as pond liners, usually require protection against damage to ensure they retain their barrier properties. A small hole in the liner can result in significant water leakage, especially over time. In some cases, for example in containing mining waste where the water is contaminated and is being retained or directed to protect the environment, small amounts of leakage can have a significant effect and can cause substantial environmental harm, and potentially incur large costs to rectify. In such applications the integrity of the liner is critical, as is the ability to determine and monitor that integrity at all times.

In other applications where water is being retained for further use, the loss of that water has a cost which merits an investment in ensuring barrier integrity.

To protect the liner from damage during and after installation, an underlay is often laid under the liner. The underlay is typically an electrically insulating, water permeable, low cost, non-woven synthetic textile. Often the ground is prepared to minimise the risk of damage to the liner. The earth itself can also form part of a multi-layer approach to water retention, such as where the ground surface is formed from clay. If required, multiple layers of barrier liner and/or underlay are used.

One or more layers of geotextile may be placed on top of the barrier layer to protect the barrier layer from materials placed on top of the barrier layer, such as earth, gravel or landfill waste.

Inspection of barrier integrity can include electrical inspection, where a voltage is applied to the surface of the insulating barrier and under the right conditions a circuit can be formed through any defects in the barrier material. For a circuit to be formed, an electrical conduction mechanism on the opposite side of the barrier to which the voltage is applied is required. Where an electrolyte, even a very weak one, is present under the barrier, sufficient current can be carried to form a circuit through the defect and to the inspection equipment. For example, clay is often a sufficient electrolyte due to its salt and water content.

To assist with the formation of a conducive pathway water can be used as part of the structure, to facilitate the inspection process. In cases where the clay is dry it does not function as an electrolyte, so the conductive inspection mechanism becomes unreliable. In cases where multiple layers of insulator are present in the barrier layer no reliable mechanism for forming a circuit exists.

To overcome this problem of reliability, several approaches have previously been proposed in this technical field to introduce reliable electrical conductivity into this type of assembly. One approach involved incorporating metal wires with the insulating underlay. This has been tried by: incorporating the wires into a textile; by sandwiching them between two layers of a textile; and by laying them onto a textile. Another approach has been to make the barrier liner as a bi-layer with the surface (water facing side) being electrically insulating and the opposing side being electrically conducting, for example by the lamination of two layers of plastic, the opposing side layer containing carbon black to provide electrical conduction. Similarly, three or more layers have been used in the barrier layer.

However, all of these approaches present problems in one or all of: the manufacture of the various layers; the installation of the various layers; or the inspection of the assembly.

Accordingly, it is an object of the invention to provide a reliable way to that ameliorates at least some of the problems associated with the prior art.

### SUMMARY OF THE INVENTION

According to a first aspect of the invention, there is provided an electrically conductive textile incorporating graphene. Said textile may incorporate fibres containing graphene, fibres coated with graphene, or alternatively the textile may be coated with graphene.

Graphene is composed of one or more individual molecular layers of graphite carbon. It can be formed by many techniques, including “top-down” approaches such as mechanical or electrochemical exfoliation of graphite, chemical oxidation of graphite and exfoliation as graphene oxide followed by partial or complete reduction to graphene; and “bottom-up” approaches such as growth from gases or plasmas on substrates or catalysts. The character of the graphene can vary from nearly atomically perfect single layers through two-layer, few-layer and multi-layer graphene all the way up a scale of number of layers which culminates in large agglomerates, similar to ultra-fine graphite.

Graphene has a high aspect ratio, being ultimately only one atomic layer thick (less than one nanometre) and typically hundreds of nanometres to hundreds of microns in the planar directions. Thus, graphene is referred to as being a two-dimensional (2D) material. Graphene is also an excellent electrical conductor.

The inventors have found that graphene can be incorporated into and onto fibres and textiles to form an electrically conducting textile that provides a reliable mechanism for inspection of barrier liners in water retention applications, providing substantial advantages over other proposed methods for inspection of barrier liners.

Preferably, the electrical conductivity of a circuit formed in said textile may be measured over a distance of at least 1 metre, advantageously up to 100 metres or more.

Preferably, the graphene content of the textile is less than or equal to 20% by mass, or advantageously less than or equal to 10% by mass, or advantageously less than or equal to 5% by mass.

Preferably, the fibres of the textile are polymer fibres, for example polyethylene terephthalate (PET), polypropylene (PP) or polyethylene (PE).

According to another aspect of the invention, there is provided a multi-layer construction incorporating the textile as described above. Preferably, the multi-layer construction further incorporates a water barrier layer, which is preferably an electrical insulator.

Such multi-layer constructions may advantageously be used as part of an inspection process to determine whether the water barrier is intact.

According to another aspect of the invention, there is provided a method of inspecting the integrity of a water barrier, wherein said water barrier incorporates a multi-layer construction as described above, said method including the steps of: applying a voltage to one side of the insulating water barrier proximal to said electrically conductive textile; and detecting whether an electrical circuit is thereby formed in the textile.

Electrical resistance can be reported in many ways. For electrical conduction in a thin sheet, the unit “Ohms per square” (“Ohm/sq” or “Ohm/□”) is often used and referred to as “sheet resistance”. This unit is of practical advantage in that it reflects a desired outcome regardless of how the material being measured is constructed. For example, two sheets of electrical conductor may have different specific resistances but give the same, desirable sheet resistance if present in different thicknesses. Sheet resistance is normally applied to uniform thickness films, but can also be applied to non-uniform sheets of conductor, such as the textiles described here.

There are many methods of measuring electrical resistance, including simple multimeters readings. Where high resistances are present, such as in the case of some embodiments of conductive geotextiles, a high voltage measurement is useful, such as those given by electrical insulation resistance meters (commonly called megaohm meters, or by the commercial name “Megger” or “Meggar”).

Industrial applications often use high voltage “Holiday” detectors to detect defects in insulating layers. A simple high voltage, low current source such as a Tesla coil can also be used to detect electrical conductivity at very low levels. More accurate measurements are given by four-point resistance meters.

Preferably, the electrical resistance of said textile is less than 2500 Ohms per square, advantageously as low as 50 Ohms per square, or lower.

Preferably, the measurement method employs a discontinuous electrical circuit via a capacitance and the resistance of the textile is less than 500,000 Ohms per square, advantageously as low as 50,000 Ohms per square, or lower.

Now will be described, by way of a specific, non-limiting example, a preferred embodiment of the invention with reference to the drawings.

### BRIEF DESCRIPTION OF THE DRAWINGS

FIG. 1 is a schematic of an inspection circuit used to detect defects in a multi-layer sheet that acts as a barrier layer according to the invention.

FIG. 2 is a schematic of an alternative inspection circuit used to detect defects in a multi-layer sheet that acts as a barrier layer according to the invention.

FIG. 3 is a schematic of an alternative inspection circuit used to detect defects in a multi-layer sheet that acts as a barrier layer according to the invention.

FIG. 4 is a schematic of an alternative inspection circuit used to detect defects in a multi-layer sheet that acts as a barrier layer according to the invention.

FIG. 5 is a schematic of an alternative inspection circuit used to detect defects in a multi-layer sheet that acts as a dual barrier layer according to the invention.

### DETAILED DESCRIPTION OF THE INVENTION

The invention resides fundamentally in the use of graphene as an electrically conducting component of a polymer fibre for a textile that is adapted for use, for example, as a layer in a multi-layer construction that acts as a water barrier for man-made earthworks. The invention provides a way to test the sheet for defects, such as holes, via the electrical properties imbued in the sheet by the presence of the graphene.

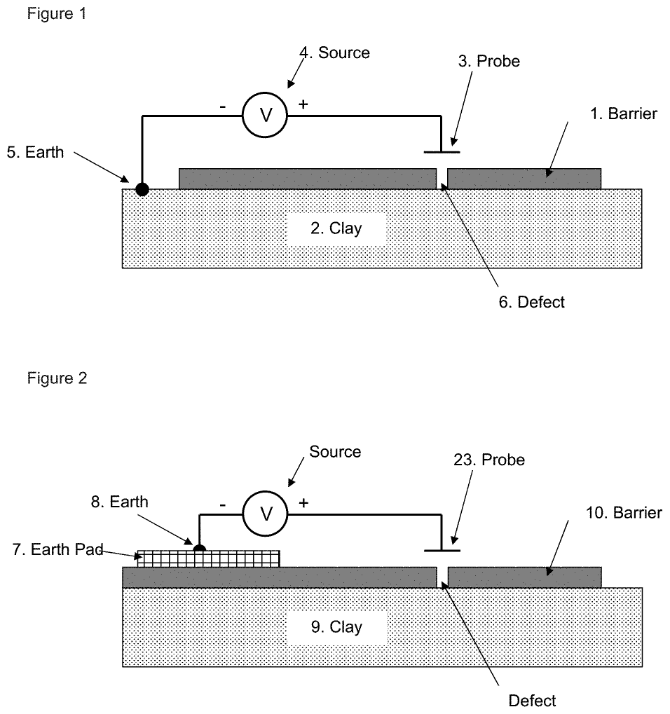

Turning to the figures, we note that FIG. 1 is a schematic illustration of an inspection circuit used to detect for defects in a barrier layer 1 using a voltage/current source 4. When the inspection probe 3 is close to a defect 6 (such as a hole), current will flow through the defect 6 into the electrically conducting clay base 2 via the earth contact 5 to form a continuous circuit.

FIG. 2 is a schematic illustration of an alternative configuration of the inspection system of FIG. 1. Instead of direct contact by the earth 8 to the clay base 9, a relatively large area earth pad 7 is used to provide indirect electrical contact via a capacitance, where the barrier layer 10 provides a dielectric between the earth pad 8 and the clay base 9.

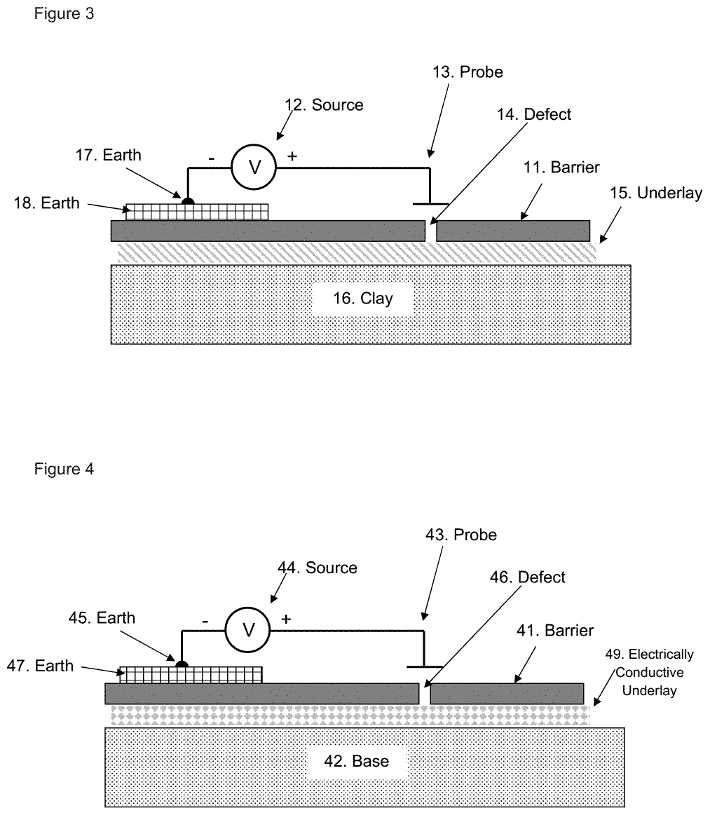

FIG. 3 is a schematic illustration of an inspection circuit used to detect defects in a barrier layer 11 using a voltage/current source 12. When the inspection probe 13 is in close proximity to a defect 14, current flows through the defect 14 into and through the underlay 15 and/or the clay base 16 via the earth contact (17, 18) to form a circuit. The underlay 15 may play an active role if it contains sufficient electrolyte.

FIG. 4 is a schematic illustration of an inspection circuit used to detect defects in a barrier layer 41 using a voltage/current source 44. When the inspection probe 43 is in close proximity to a defect 46, current flows through the defect 46 into and primarily through the electrically conductive underlay 49 via the earth (45, 47) contact to form a circuit.

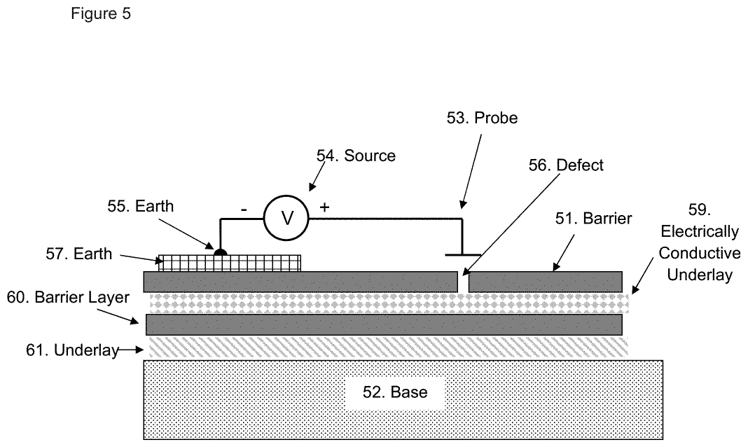

FIG. 5 is a schematic illustration of an inspection circuit used to detect for defects in a dual barrier Layer (51, 60) using a voltage/current source 54. When the inspection probe 53 is in close proximity to a defect 56, current flows through the defect 56 into and primarily through the electrically conductive underlay 59 via the earth (55, 57) contact to form a circuit. Additional underlay 61 is not required to be electrically conductive but can optionally be so to ensure the barrier layer 10 has been laid without defects.

FIG. 1 illustrates an example of the circuit formed when electrical leak detection is performed on a simple water barrier assembly with a conductive under-layer such as a water-containing clay base. Clay is used in many cases to prepare the ground for water retention (e.g. dams and ponds) and water direction (e.g. canals and drainage). Clay also provides a good medium for electrical conduction due to its water and ionic content. If the clay base is partially or completely dry this process is not reliable and may not work at all. Also, if there is poor physical contact between the barrier layer and the clay base, caused by for example, air or water pockets, the inspection process can be unreliable. In the absence of a clay base, or equivalent, the inspection process is unreliable.

Electrical inspection techniques are typically classified as either low-voltage or high-voltage. Low-voltage techniques typically require an electrically conductive layer on both sides of the membrane. This is provided by water being present in the area being inspected (often referred to as “water lance” or “water puddle” techniques). High-voltage techniques (often referred to as “arc” or “spark” techniques) do not require a conductor on the side of the barrier layer being inspected (typically the “top” layer) and can use many thousands of volts to ensure that small holes, even pinholes, can be detected.

Two principal mechanisms of forming an earth connection are illustrated in FIG. 1 and FIG. 2. In FIG. 1 an earth 5 is formed where the electrical conductor is connected to the conducting under-layer (not shown in FIG. 1), e.g. by inserting a metal rod into the clay base, or by attaching to the conductive textile under-layer. In FIG. 2 an area of conductor, the earth pad 7 rests on top of the nominally insulating barrier layer 10. In some instances, the barrier layer 10 is not a perfect insulator so over a large contact area such as that formed by the earth pad 7 enough current can flow to through the circuit between the probe 23 and the earth 8. In other instances, the barrier layer 10 acts as a dielectric and the earth pad (7) acts as one electrode of a capacitor.

FIG. 3 illustrates a common practice of including an underlay 15 of textile to protect the barrier layer 11 from damage and/or to provide a mechanism for drainage.

If the textile under-layer is made electrically conducting then, as illustrated in FIG. 4, the base 42 can be any material and no other conductivity beneath or in the barrier layer 41 is required. The incorporation of graphene into or onto the underlay textile can make the textile sufficiently electrically conductive to allow both low and high voltage inspection techniques to be performed depending on the thickness of the barrier layer 41 and the size of the defect 46 that needs to be detected. The larger the defect 46, and the thinner the barrier layer 41, the lower the voltage required for inspection. FIG. 4 illustrates this configuration with the Electrically Conductive Underlay (9) and the inspection configuration.

In cases where improved barrier protection is desired two layers of barrier material (or more) can be included. The incorporation of two layers of insulator without the electrically conductive underlay mean that unless a defect occurs in both barrier layers at the same place, electrical detection of defects does not work. By including a layer of electrically conductive material between the two barrier layers, electrical detection is again feasible.

FIG. 5 illustrates such a multi-layer structure with two barrier layers (51, 60), with an electrically conductive underlay 59 located in between the two barrier layers, and a further underlay 61 to protect the barrier layer 60 from the ground and/or to provide drainage. The underlay 61 is not required to be electrically conductive to enable inspection of the barrier layer 51, but where an inspection of barrier layer 60 is also desired, the underlay 61 can be made electrically conductive.

Electrical inspection for defects in the barrier layer can be performed by many methods. Industrial standards have been set to normalise the inspection conditions. These are embodied, for example, in: ASTM D6747, ASTM D7002, ASTM D7007, ASTM D7240, ASTM D7703 and ASTM D7852.

Electrical inspection methods rely on electrical conductivity to form a circuit. Sufficient conductivity depends on the size and length of the conductive path and the conductivity of the media (water, earth, conductive textile, barrier layer). This combination of variables gives a wide range over which the inspection methods can be effective. Tuning the inspection method to the desired outcome and conditions is required. This allows the electrical conductivity of the conductive textile to also be tailored to the desired application and inspection methods. In some cases, the electrical conductivity of the conductive textile can be quite low, such as where the inspection voltage is high, the defect size is large and the circuit path is short.

Geotextiles are permeable fabrics which, when used in association with soil, have the ability to separate, filter, reinforce, protect, or drain. Typically made from synthetic fibres, such as polypropylene or polyester but potentially including other synthetic fibres, such as: polyimide; acrylonitrile; polylactide; polyester; cellulose; polyurethane; polyethylene and/or semi-synthetic fibres, such as: regenerated cellulose and/or natural fibres, which are primarily cellulosic, such as: abaca; cotton; flax; jute; kapok; kenaf; raffia; bamboo; hemp; modal; pine; ramie; sisal, or; soy protein. Natural fibres are often biodegradable while synthetic fibres are not, thus appropriate fibre selection depends on the application.

Geotextile fabrics, like other fabrics, can be formed from fibres by many methods, including: weaving, knitting, knotting, braiding and non-woven overlay techniques where further steps, such as inter-tangling (e.g. needle punch, felting, hydro-entanglement, spun-lacing, water needling) and can include various steps to improve the desired properties, such as carding and heat bonding.

Geotextiles are so named for their use in civil engineering applications including: airfields; bank protection; canals; coastal engineering; dams; debris control; embankments; erosion; railroads; retaining structures, reservoirs; roads; sand dune protection; slope stabilisation; storm surge; stream channels; swales and; wave action.

Various forms of graphene exist. Ideal graphene is pure carbon and is the best electrical conductor in the graphene family. It can be manufactured free of defects and other chemical functionality, such as the presence of oxygen molecules.

Graphene oxide (GO) is a highly oxidised form of graphene that is an electrical insulator. Intermediary species can be referred to by various descriptions, such as partially reduced graphene oxide (prGO) or functionalised graphene, where various chemical groups are attached to the edges and/or basal planes of the graphene. This functionality allows tailoring of the electrical and physical properties of the graphene, for example to make it easier to incorporate into or onto materials, such as plastics to form composites. Incorporation of heteroatoms, where carbon atoms are replaced by other atoms (e.g. nitrogen and/or other covalently bonded atoms) can also be used to tailor the properties of graphene.

Graphene can also come in various dimensions, whether it be single layers of graphene or multiple layers. Various terminologies have been used to describe the structural permutations and some attempts have been made at standardising terminology. Regardless of terminology these single-layer and multi-layer structures of graphene have useful conductivity that give rise to the properties in polymers, fibres and textiles as described here. These various permutations of graphene are generalised here as “graphene” unless otherwise detailed and their properties described.

The continuum scale from electrically conductive to electrically insulating means many forms of graphene can be used as an electrical conductor and even poorly conducting graphene can serve the purpose, especially where it's other properties make it desirable for use.

Graphene can be produced by many routes, including: anodic bonding; carbon nanotube cleavage; chemical exfoliation; chemical synthesis; chemical vapour deposition; electrochemical exfoliation; electrochemical intercalation; growth on silicon carbide; liquid phase exfoliation; micromechanical cleavage; microwave exfoliation; molecular beam epitaxy; photo-exfoliation; precipitation from metal, and; thermal exfoliation. Some of these routes give rise to materials referred to as: chemically converted graphene; few-layer graphene; GO; graphene; graphene oxide; graphene nanoflakes; graphene nanoplatelets; graphene nanoribbons; graphene nanosheets; graphite nanoflakes; graphite nanoplatelets; graphite nanosheets; graphite oxide; LOGO; liquid crystal graphene oxide; multi-layer graphene; partially reduced graphene oxide; partially reduced graphite oxide; prGO; rGO; reduced graphene oxide; reduced graphite oxide.

Incorporation of graphene into a textile can be achieved by different methods. In each case the properties of the fibre and textile will depend on the fibre chemistry, graphene chemistry, graphene shape and processes used to incorporate the graphene into or onto the fibres and the process of forming a textile.

Preferred methods include mixing the graphene into the polymer prior to forming the fibre. However, it is also possible to coat fibres or a textile with graphene to make the conductive textile. The graphene can be present as a powder or as a dispersion in a fluid to facilitate dispersion of the graphene in the polymer. Coating the graphene is preferably from a dispersion of graphene in a fluid. Suitable methods of incorporation of graphene into the polymer include: Melt-compounding of graphene into the polymer; in-situ polymerisation of the polymer with the graphene, and; solution blending. Whichever technique is used, it is desirable that the graphene is sufficiently dispersed to achieve electrical conductivity.

Additives may be used to reduce phase separation of the graphene and the polymer. Conductive additives can be added to the graphene coating or to the graphene-containing polymer. These conductive additives can improve the effectiveness of the graphene in providing electrical conductivity. For example, carbon blacks, carbon fibres and/or carbon nanotubes are all conductive carbons that can assist with the dispersion of the graphene in the coating liquid or in the polymer mixture and provide further interconnectivity.

A preferred embodiment includes the textile being formed from a fibre that includes graphene, wherein the fibre is formed by melt extrusion from pellets or powders of the polymer. The graphene is added to the melt extrusion in a concentrated form dispersed in a carrier polymer, which may be the same as the bulk polymer, or may be different. The concentrated form of the graphene polymer dispersion is mixed and diluted in the melt extrusion process to obtain the desired concentration of graphene in the fibres.

In an alternative embodiment, the concentrated form of the graphene is dispersed in a fluid, such as: oil, solvent or water.

Example 1—Squares of approximately 10 cm² of ‘bidim A14’ geotextile (non-woven PET) as produced by the company Geofabrics (www.geofabrcs.com.au) were coated with a dispersion of graphene in xylene by repeatedly dipping the geotextile by hand into the dispersion of graphene until the geotextile became black. After air drying the conductivity was measured to be 2000 Ohms/sq.

Example 2—Squares of approximately 10 cm² of ‘bidm A14’ geotextile (non-woven PET) as produced by the company Geofabrics was coated with a dispersion of graphene in ethanol by repeatedly dipping the geotextile by hand into the dispersion of graphene until the geotextile became black. After air drying the conductivity was measured to be 200 Ohms/sq.

Example 3—Squares of 10 cm² of ‘bidm A14’ geotextile (non-woven PET) as produced by the company Geofabrics was coated with a dispersion of graphene in ethanol by dipping the geotextile by hand into the dispersion of graphene and leaving it immersed until the geotextile became black. After air drying the conductivity was measured to be 500 Ohms/sq.

Example 4—Strips approximately 5 cm by 2 cm of ‘bidim A14’ geotextile (non-woven PET) as produced by the company Geofabrics was coated with a dispersion of graphene oxide in water by repeatedly dipping the geotextile by hand into the dispersion of graphene and leaving it immersed until the geotextile became dark brown. The coated geotextile was then treated with citric acid as a reducing agent to convert the graphene oxide to graphene. After air drying the conductivity was measured to be 870 Ohms/sq.

Example 5—Sheets approximately 10 cm² of ‘bidim A14’ geotextile (non-woven PET) as produced by the company Geofabrics was coated with a dispersion of graphene in ethanol by spraying the geotextile with a dispersion of graphene until the geotextile became black. The geotextile was then passed through a pair of compressing rollers. After air drying the conductivity was measured to be approximately 10,000 Ohms/sq on both sides of the geotextile.

Example 6—Sheets approximately 10 cm² of ‘bidim A14’ geotextile (non-woven PET) as produced by the company Geofabrics was coated with a dispersion of graphene in water by spraying the geotextile with a dispersion of graphene until the geotextile became black. After air drying the conductivity was measured to be 30,000 Ohms/sq on each side of the geotextile.

Example 7—An approximately A4-sized sheet of geotextile made by the same process as Example 2 was placed under a similar sized sheet of electrically insulating waterproof membrane with holes made in it. The holes ranged from a pinhole to an approximately 4 cm² hole. Inspection with a handheld “holiday detector” (as described in ASTM D7240 gave 100% detection of the holes.

Example 8—Graphene was blended into PP at 10 wt % by melt compounding and extruded to form pellets. The pellets were subsequently extruded to form approximately 25 micron diameter fibre. The individual fibres were electrically conductive and when assembled by hand into a mat of non-woven textile the textile was electrically conductive when measure by a Holiday detector.

Example 9—Graphene was blended into PET at 15 wt % by melt compounding and extruded to form pellets. The pellets were subsequently extruded to form approximately 25 micron diameter fibre. The individual fibres were electrically conductive and when assembled by hand into a mat of non-woven textile the textile was electrically conductive when measured by a holiday detector.

Example 10—An acrylic dispersion of graphene was blade-coated onto an approximately 150 gsm (gram per square meter) commercial non-woven, needle-punched polyester geotextile. Sixty linear meters of 2 m wide (120 square meters) geotextile was coated on one side with 60 grams per square meter (dry weight) of dispersion. The coated geotextile was dried at 150° C. for 2 minutes in an inline stent or oven. The dry graphene content equates to 20 grams per square meter. The dry coated geotextile had a sheet resistance of 1000 Ohms per square.

The conductive geotextile was tested as a leak detection system by laying a first, electrically insulating layer consisting of 15 m of 2 m wide (30 square meters) of 2.0 mm thick HDPE waterproof membrane on the ground. A second layer consisting of 12 m of approximately 1.6 m wide (19 square metres) conductive geotextile was laid on top of the HDPE layer. A third layer consisting of 12 m of 2 m wide (36 square metres) of 2.0 millimetre thick HDPE waterproof membrane was laid on top of the second layer. A series of holes spaced 250 millimetres apart were drilled in the third layer (the top HDPE membrane) of sizes 5, 4, 3, 2 and 1 millimetre diameter.

A series of tests were conducted with an Elcometer 266 DC Holiday Meter to evaluate the effectiveness of the conductive geotextile to determine holes in the third layer under a range of variables. Successful detection of all holes was achieved at voltages from 5000 to 30,000 Volts and with brush speeds up to two meters per second.

Example 11—The arrangement and materials from Example 10 were modified by cutting the second layer (conductive geotextile) in two across its width, forming two pieces of conductive geotextile. An electrical connection between the two pieces of the second layer was formed by bring the two pieces into contact. No special join was made or required. Overlaying one piece of the second layer with the other piece of the second layer was sufficient to allow effective leak detection in the third layer. With even partial contact of the two pieces, no reduction in efficacy of the testing was measured. When the second layer was joined with an overlay of the specified recommended 100 mm overlap for adjacent sheets of unmodified geotextile, no difference could be observed in the electrical performance of the leak detection system with the join as compared with example 10.

Example 12—Similarly to Example 10, 100 square meters of 2 m wide, approximately 190 gsm geotextile was coated with an acrylic emulsion of graphene. The dry weight of the coating is approximately 39 gsm, with the graphene content being approximately 13 gsm. Electrical conductivity was measured as 3600 Ohms per square. All other properties were found to be within the normal specification of the unmodified geotextile.

Example 13—Similarly to Example 12, 400 square meters of 2 m wide 190 gsm geotextile was coated with 5 gsm graphene in an acrylic emulsion. Electrical conductivity was measured as 2600 Ohms per square. Electrical testing by an independent third party found effective hole detection using a holiday meter down to 1.0 mm diameter holes at as little as 1000 Volts.

Example 14—A comparison study of a commercial HDPE waterproof membrane with an electrically conductive backing designed to facilitate hole detection was tested in parallel with Example 13. The commercial conductive geomembrane was measured to be ineffective at detecting holes of 2.0 mm or less at 5000 Volts or less.

Example 15—A comparison study of a commercial electrically conductive geotextile that uses metal threads to provide electrical conductivity was tested in parallel with Example 12. The commercial conductive metal thread geotextile was measured to be ineffective at detecting holes of 1.0 millimetres at 5000 Volts or less.

It will be appreciated by those skilled in the art that the above described embodiment is merely one example of how the inventive concept can be implemented. It will be understood that other embodiments may be conceived that, while differing in their detail, nevertheless fall within the same inventive concept and represent the same invention.

1. An electrically conductive textile for use as part of an inspection process to determine whether a water barrier is intact wherein said electrically conductive textile incorporates graphene; or wherein said electrically conductive textile incorporates fibres coated with graphene; or wherein said electrically conducted textile is coated with graphene; or wherein said electrically conductive textile is made from fibres containing graphene; wherein the electrical conductivity of a circuit formed therefrom may be measured over a distance of at least 10 meters; and wherein the graphene content of the textile is less than or equal to 20% by mass.

2-4. (canceled)

5. The textile of claim 1, wherein the distance is at least 1 metre.

6. (canceled)

7. The textile of claim 1, where in wherein the distance is at least 100 metres.

8. (canceled)

9. The textile of claim 1, wherein the graphene content of the textile is less than or equal to 10% by mass.

10. The textile of claim 1, wherein the graphene content of the textile is less than or equal to 5% by mass.

11. The textile of claim 1, wherein the graphene content of the textile is less than or equal to 2% by mass.

12. The textile of claim 1, wherein the fibres of the textile are polymer fibres.

13. The textile of claim 12, wherein said polymer is PET, PP or PE.

14. A multi-layer construction incorporating the textile of claim 1; said construction incorporating a water barrier layer that is an electrical insulator.

15-16. (canceled)

17. A multi-layer construction, according to claim 14, for use as part of an inspection process to determine whether the water barrier is intact.

18-26. (canceled)

27. A method of configuring an electrically conductive textile to incorporate graphene, comprising:
incorporating the textile of claim 1 into a multi-layer construction that includes a water barrier layer that is an electrical insulator;
performing an inspection process to determine whether the water barrier layer is intact;
applying a voltage to one side of a sheet proximal to said electrically conductive textile, wherein the resistance of said textile is less than 2500 Ohms per square; and
detecting whether an electrical circuit is thereby formed in the textile.
